(19) United States
(12) Patent Application Publication
(10) Pub. No.: US 2022/0282555 A1
(43) Pub. Date: Sep. 8, 2022

(54) COMMUNICATION SYSTEM, MANAGEMENT DEVICE, AND TERMINAL DEVICE

(71) Applicant: Hideo EBIZAWA, Aichi (JP)

(72) Inventor: Hideo EBIZAWA, Aichi (JP)

(73) Assignee: NIDEC MOBILITY CORPORATION, Aichi (JP)

(21) Appl. No.: 17/686,412

(22) Filed: Mar. 4, 2022

(30) Foreign Application Priority Data
Mar. 5, 2021 (JP) 2021-035331

(51) Int. Cl. E05F 15/75; H04L 1/08; E05F 15/695; E05F 15/697

(52) U.S. Cl. CPC E05F 15/75; H04L 1/08; E05F 15/695; E05F 15/697; E05Y 2201/434; E05Y 2400/42; E05Y 2400/854; E05Y 2400/858; E05Y 2900/55

(57) ABSTRACT

In a communication system, a management device transmits a confirmation request signal requesting confirmation of a state of a terminal device to each of a plurality of terminal devices at the same timing all at once. Each of the terminal devices returns the notification information to the management device together with terminal identification information for identifying the terminal device in a case where there is notification information. The management device identifies the terminal device that has returned the notification information based on the terminal identification information in a case where the notification information is returned from the plurality of terminal devices at the same timing, and individually re-transmits the confirmation request signal to the identified terminal devices at different timings. The terminal device, which has received the re-transmitted confirmation request signal, re-returns the notification information to the management device together with the terminal identification information.

### CROSS-REFERENCE TO RELATED APPLICATIONS

This application is based upon and claims the benefit of priority from Japanese Patent Application No. 2021-035331 filed on Mar. 5, 2021, the entire contents of which are incorporated herein by reference.

### FIELD

One or more embodiments of the present invention relate to a communication system that communicates between a management device constituting a master unit and a terminal device constituting a slave unit.

### BACKGROUND

A communication system in which a master unit and a plurality of slave units are coupled by a communication line, a response request signal is transmitted from the master unit to each slave unit, and the slave unit that receives this signal returns a response signal to the master unit has traditionally been well known, as described in JP-A-2007-288312, JP-A-2006-287354, JP-A-2007-221522, and JP-A-H11-285085. For example, in a four-wheeled vehicle, in-vehicle devices such as a power window device and an electric mirror are mounted, and the above-mentioned communication system is constructed in order to control these devices.

FIG. 16 shows an example of a power window system 1B using such a communication system. Power window devices PW10, PW20, PW30, and PW40 that constitute the system are devices for opening and closing the windows of a vehicle, and are provided corresponding to a driver seat DR, an assistant seat AS, a rear left seat RL, and a rear right seat RR, respectively.

The power window device PW10 of the driver seat DR includes a main control unit 110 corresponding to a master unit, a main switch 111, and a motor 112. The main switch 111 is provided with a driver seat switch for operating the opening and closing of the driver seat DR window at hand, and another seat switch for remotely operating the opening and closing of each window of the assistant seat AS, the rear left seat RL, and the rear right seat RR (not shown). The motor 112 is rotated by operating the driver seat switch to open and close the window of the driver seat DR. The main control unit 110 controls the motor 112 based on the operation of the driver seat switch.

The power window device PW20 for the assistant seat AS includes a sub-control unit 120 corresponding to a slave unit, an assistant seat switch 121, and a motor 122. The assistant seat switch 121 is a switch for operating the opening and closing of the window of the assistant seat AS at hand. The motor 122 is rotated by the operation of the assistant seat switch 121 or the operation of the assistant seat switch provided in the main switch 111 of the driver seat DR to open and close the window of the assistant seat AS. The sub-control unit 120 controls the motor 122 based on the operation of these switches.

The power window device PW30 of the rear left seat RL includes a sub-control unit 130 corresponding to a slave unit, a rear left seat switch 131, and a motor 132. The rear left seat switch 131 is a switch for operating the opening and closing of the window of the rear left seat RL at hand. The motor 132 is rotated by the operation of the rear left seat switch 131 or the operation of the rear left seat switch provided in the main switch 111 of the driver seat DR to open and close the window of the rear left seat RL. The sub-control unit 130 controls the motor 132 based on the operation of these switches.

The power window device PW40 of the rear right seat RR includes a sub-control unit 140 corresponding to a slave unit, a rear right seat switch 141, and a motor 142. The rear right seat switch 141 is a switch for operating the opening and closing of the window of the rear right seat RR at hand. The motor 142 is rotated by the operation of the rear right seat switch 141 or the operation of the rear right seat switch provided in the main switch 111 of the driver seat DR to open and close the window of the rear right seat RR. The sub-control unit 140 controls the motor 142 based on the operation of these switches.

The main control unit 110 (master unit) of the driver seat DR and the sub-control units 120, 130, and 140 (slave units) of the other seats are coupled by a communication line L5. Further, the main switch 111 of the driver seat DR is also coupled to the communication line L5. The main control unit 110 is further coupled to an electronic control unit (ECU) 160 that controls the entire vehicle via a communication line L6.

The main control unit 110 periodically transmits a confirmation request signal requesting confirmation of each state (status) to the sub-control units 120, 130, and 140 via the communication line L5. When receiving this confirmation request signal, the sub-control units 120, 130, and 140 confirm the state thereof (standby, window closing operation, window opening operation, failure occurrence, and the like) and returns a response signal including the result to the main control unit 110 via the communication line L5. The main control unit 110 grasps the state of each sub-control unit based on the response signals from the sub-control units 120, 130, and 140, and notifies the ECU 160 via the communication line L6 in a case where a failure or the like occurs.

In the power window system 1B as described above, in a case where a seat other than the driver seat DR, for example, the rear left seat switch 131 of the rear left seat RL is operated, in related art, the sub-control unit 130 determines the operation state (manual operation, automatic operation, window closing operation, window opening operation, and the like) of the switch, controls the motor 132 to rotate forward or reverse, and returns the result to the main control unit 110. The same applies to the operations of the sub-control units 120 and 140 in a case where the assistant seat switch 121 of the assistant seat AS and the rear right seat switch 141 of the rear right seat RR are operated.

In this method, since the sub-control units 120, 130, and 140 determine the operation state of the switch thereof and drive the motor, the time from the switch operation to the motor drive can be shortened. However, for example, when the window is closed by the rear left seat switch 131 of the rear left seat RL and the window is opened by the rear left seat switch of the main switch 111 of the driver seat DR, the contradictory operations are performed at the same time, and the motor 132 of the rear left seat RL may become uncontrollable.

As a countermeasure, in a case where the switches 121, 131, and 141 of the sub-control units 120, 130, and 140 are operated, a method can be considered in which each sub-control unit transmits the operation state of the switch to the main control unit 110 via the communication line L5, and the main control unit 110 confirms the operation state of each of the switches 111, 121, 131, and 141, and then transmits a command signal for commanding permission/disapproval of motor drive to each sub-control unit via the communication line L5. The sub-control units 120, 130, and 140 drive the motors 122, 132, and 142 when a permission command is received, and do not drive the motors 122, 132, and 142 when a disapproval command is received.

According to the above method, it is possible to avoid a situation in which the motor becomes uncontrollable even in a case where contradictory operations are performed on the switches 111, 121, 131, and 141 at the same time. However, on the other hand, since the sub-control units 120, 130, and 140 cannot transmit the operation state of the switch until the sub-control units receive the confirmation request signal addressed thereto, which is sequentially transmitted from the main control unit 110, and the motors 122, 132, and 142 cannot be driven until the permission command is received from the main control unit 110, there arises a problem that it takes time from the switch operation to the opening and closing of the window.

Therefore, not only in the power window system described above, but also in a system that communicates between the master unit and the plurality of slave units, it is required to shorten the communication time and improve the communication efficiency.

JP-A-2007-288312 discloses a technique for avoiding a collision of response signals returned from slave units to a master unit and shortening the communication time. JP-A-2006-287354 discloses a technique for allocating a line in a short time even in a case where the number of slave units increases. JP-A-2007-221522 discloses a technique for suppressing the amount of data of identification information of a slave unit in a polling signal to improve communication efficiency. JP-A-H11-285085 discloses a technique for shortening the collection time of a response signal by sending a common monitoring request signal from a master unit to a slave unit.

### SUMMARY

An object of one or more embodiments of the present invention is to provide a communication system that can shorten the communication time between a master unit and a slave unit and can handle data even in a case where the data is transmitted from a plurality of slave units to the master unit at the same time.

A communication system of one or more embodiments of the present invention includes a management device that constitutes a master unit, a terminal device that constitutes a slave unit, and a communication line that couples the management device and the terminal device. A plurality of terminal devices is provided, and the management device and the plurality of terminal devices communicate with each other via the communication line. The management device transmits a confirmation request signal requesting confirmation of a state of the terminal device to each of the plurality of terminal devices at the same timing all at once. In response to reception of the confirmation request signal, each of the plurality of terminal devices confirms the state of the terminal device to determine whether or not there is notification information of which the management device is to be notified. In a case where there is notification information, each of the plurality of terminal devices returns the notification information to the management device together with terminal identification information for identifying the terminal device. In a case where notification information is returned from the plurality of terminal devices at the same time, the management device identifies the terminal devices that has returned the notification information based on the terminal identification information, and individually re-transmits the confirmation request signal to each of the identified terminal devices at different timings. The terminal device, which has received the re-transmitted confirmation request signal, re-returns the notification information to the management device together with the terminal identification information in a case where there is notification information.

According to such a communication system, since confirmation request signals are transmitted from the management device (master unit) to all terminal devices (slave units) at the same timing, in response to reception of the confirmation request signal, the terminal device that needs to notify the management device can immediately return the notification information to the management device, and can shorten the communication time between the management device and the terminal device. Further, in a case where notification information is returned from the plurality of terminal devices to the management device at the same time, the management device identifies the terminal devices that has returned the notification information based on the terminal identification information, and individually re-transmits the confirmation request signal to those terminal devices, and the terminal device that receives this confirmation request signal re-returns the notification information to the management device. Therefore, the management device can transmit a command signal corresponding to the notification information to each of the terminal devices and cause the terminal device to execute a predetermined operation.

In the communication system of one or more embodiments of the present invention, the terminal identification information may be digit information in which predetermined data is recorded in a specific digit different for each terminal device among a plurality of digits constituting a data recording area. In this case, in response to reception of terminal identification information, in a case where the predetermined data is recorded in a predetermined number of digits or more, the management device determines that the notification information is returned from the plurality of terminal devices at the same time.

Further, in the communication system of one or more embodiments of the present invention, in a case where there is a change in the state of the terminal device, the terminal device may determine that there is notification information and transmits the notification information to the management device together with the terminal identification information, and in a case where there is no change in the state of the terminal device, the terminal device may determine that there is no notification information and may not transmit the notification information to the management device.

Further, in the communication system of one or more embodiments of the present invention, the management device may include a single main control unit that communicates with the plurality of terminal devices via the communication line, and the plurality of terminal devices may include a plurality of sub-control units that individually controls each of control targets provided corresponding to each terminal device.

Further, in the communication system of one or more embodiments of the present invention, the main control unit, the sub-control units, and the communication line may be mounted on a vehicle, the sub-control unit may be provided corresponding to each seat of the vehicle, and the control target may be a motor for opening and closing a window of each seat of the vehicle.

A management device of one or more embodiments of the present invention is a management device that is coupled to a plurality of terminal devices by a communication line and communicates with the terminal devices via the communication line, and transmits a confirmation request signal requesting confirmation of a state of the terminal device to each of the plurality of terminal devices at the same timing all at once. Then, in response to reception of notification information indicating the state of the terminal device and terminal identification information for identifying the terminal device from the terminal device, the management device identifies the terminal devices that have returned the notification information based on the terminal identification information, and individually re-transmits the confirmation request signal to each of the identified terminal devices at different a time.

In the management device of one or more embodiments of the present invention, in a case where the notification information is returned from the plurality of terminal devices at the same time, the management device may individually re-transmit the confirmation request signal only to the terminal device that has returned the notification information, and may not individually re-transmit the confirmation request signal to the terminal device that has not returned the notification information.

Further, in the management device of one or more embodiments of the present invention, in a case where the notification information is returned from the plurality of terminal devices at the same time, the management device may individually re-transmit the confirmation request signal to both the terminal device that has returned the notification information and the terminal device that has not returned the notification information.

A terminal device of one or more embodiments of the present invention is a terminal device that is coupled to a management device by a communication line and communicates with the management device via the communication line, and in response to reception of a confirmation request signal requesting confirmation of a state of the terminal device, the confirmation request signal being transmitted from the management device at the same timing all at once, the terminal device confirms the state of the terminal device to determine whether or not there is notification information of which the management device is to be notified. Then, in a case where there is the notification information, the terminal device returns the notification information to the management device together with terminal identification information for identifying the terminal device. Further, in a case where the notification information is returned to the management device from a plurality of terminal devices at the same time, in response to reception of the confirmation request signal that is individually re-transmitted from the management device to each terminal device at different timings, the terminal device determines again whether or not there is notification information of which the management device is to be notified, and in a case where there is the notification information, re-returns the notification information to the management device together with the terminal identification information.

According to one or more embodiments of the present invention, it is possible to provide a communication system that can shorten the communication time between a master unit and a slave unit and handle data even in a case where the data is transmitted from a plurality of slave units to the master unit at the same time.

### BRIEF DESCRIPTION OF DRAWINGS

FIG. 1 is a block diagram of a power window system according to an embodiment of the present invention;

FIG. 2 is a diagram showing a frame structure of a header;

FIG. 3 is a diagram showing an example of ID data;

FIG. 4 is a diagram showing a frame structure of data;

FIG. 5 is a diagram showing an example of digit information;

FIG. 6 is a diagram showing an example of status information;

FIG. 7 is a diagram showing a communication procedure of Comparative Example 1;

FIG. 8 is a diagram showing a communication procedure of Comparative Example 2;

FIG. 9 is a diagram showing a communication procedure of Comparative Example 3;

FIG. 10 is a diagram showing a communication procedure of the embodiment of the present invention;

FIGS. 11A and 11B are diagrams illustrating status information when response signals overlap;

FIGS. 12A and 12B are diagrams illustrating digit information when response signals overlap;

FIG. 13 is a diagram showing another example of the communication procedure according to the embodiment of the present invention;

FIG. 14 is a block diagram showing another embodiment of the present invention:

FIG. 15 is a block diagram showing another embodiment of the present invention; and

FIG. 16 is a block diagram of a power window system of related art.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Embodiments of the present invention will be described with reference to drawings. In the following, an example in which a communication system of one or more embodiments of the present invention is applied to a power window system for a vehicle will be given.

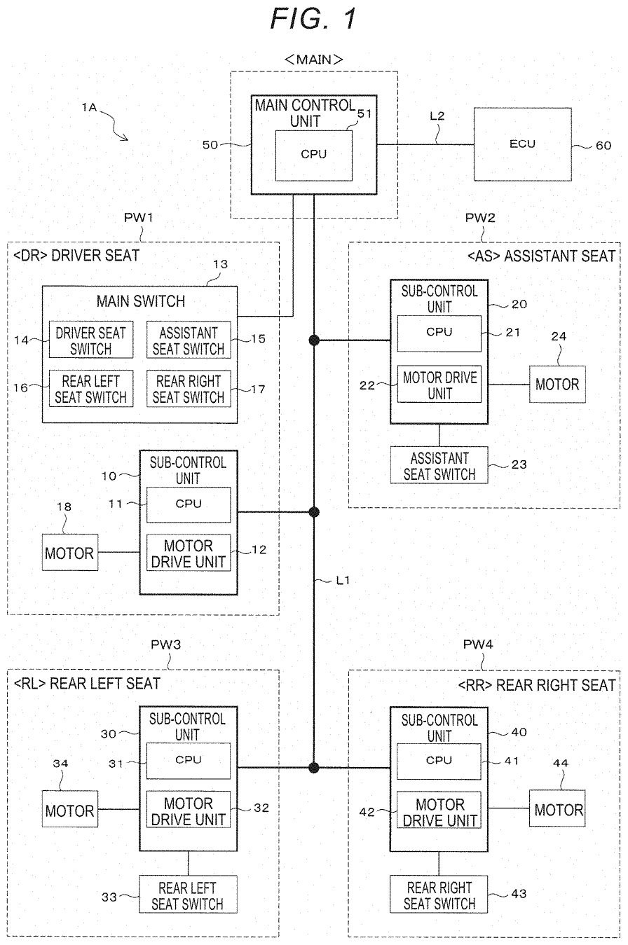

FIG. 1 shows a power window system 1A according to an embodiment of the present invention. The power window system 1A is mounted on a vehicle, for example, a four-wheeled vehicle, and includes a power window device PW1 that is provided for a driver seat DR, a power window device PW2 that is provided for an assistant seat AS, a power window device PW3 that is provided corresponding to a rear left seat RL, a power window device PW4 that is provided corresponding to a rear right seat RR, a main control unit 50 that supervises and controls these power window devices PW1 to PW4, and a communication line L1 that couples the power window devices PW1 to PW4 and the main control unit 50.

The power window device PW1 of the driver seat DR is provided with a sub-control unit 10, a main switch 13, and a motor 18. The sub-control unit 10 includes a CPU 11 and a motor drive unit 12. The main switch 13 includes a driver seat switch 14 for manually operating the opening and closing of the window of the driver seat DR, an assistant seat switch 15 for remotely controlling the opening and closing of the window of the assistant seat AS, and a rear left seat RL. It includes a rear left seat switch 16 for remotely controlling the opening and closing of windows, and a rear right seat switch 17 for remotely controlling the opening and closing of windows for the rear right seat. The motor 18 rotates by operating the driver seat switch 14 to open and close the window of the driver seat DR.

The power window device PW2 of the assistant seat AS is provided with a sub-control unit 20, an assistant seat switch 23, and a motor 24. The sub-control unit 20 includes a CPU 21 and a motor drive unit 22. The assistant seat switch 23 is a switch for operating the opening and closing of the window of the assistant seat AS at hand, and has the same function as the assistant seat switch 15 of the driver seat DR. The motor 24 rotates by operating the assistant seat switches 15 and 23 to open and close the window of the assistant seat AS.

The power window device PW3 of the rear left seat RL is provided with a sub-control unit 30, a rear left seat switch 33, and a motor 34. The sub-control unit 30 includes a CPU 31 and a motor drive unit 32. The rear left seat switch 33 is a switch for operating the opening and closing of the window of the rear left seat RL at hand, and has the same function as the rear left seat switch 16 of the driver seat DR. The motor 34 rotates by operating the rear left seat switches 16 and 33 to open and close the window of the rear left seat RL.

The power window device PW4 of the rear right seat RR is provided with a sub-control unit 40, a rear right seat switch 43, and a motor 44. The sub-control unit 40 includes a CPU 41 and a motor drive unit 42. The rear right seat switch 43 is a switch for operating the opening and closing of the window of the rear right seat RR at hand, and has the same function as the rear right seat switch 17 of the driver seat DR. The motor 44 rotates by operating the rear right seat switches 17 and 43 to open and close the window of the rear right seat RR.

The main control unit 50 is provided with a CPU 51. The main control unit 50 is coupled to each of the sub-control units 10, 20, 30, and 40 by the communication line L1, and is coupled to the electronic control unit (ECU) 60 by a communication line L2. The ECU 60 is a control unit that controls the entire vehicle. In the present embodiment, a local interconnect network (LIN) is used as the communication lines L1 and L2.

In the above configuration, the power window system 1A is an example of the “communication system” according to one or more embodiments of the inventions, the main control unit 50 is an example of the “management device” according to one or more embodiments of the inventions, and the sub-control units 10, 20, 30, and 40 are examples of the “terminal device” according to one or more embodiments of the inventions. Further, the main control unit 50 constitutes a master unit, and the sub-control units 10, 20, 30, and 40 constitute slave units. That is, the communication system of FIG. 1 is a communication system including the single management device (master unit) 50, a plurality of terminal devices (slave units) 10, 20, 30, 40, and the communication line L1 coupling therebetween.

Next, the basic operation of the power window system 1A described above will be described.

The main control unit 50 periodically transmits a confirmation request signal requesting confirmation of each state (status) to the sub-control units 10, 20, 30, and 40 via the communication line L1. As will be described later, this confirmation request signal is transmitted to all of the sub-control units 10, 20, 30, and 40 at the same timing all at once.

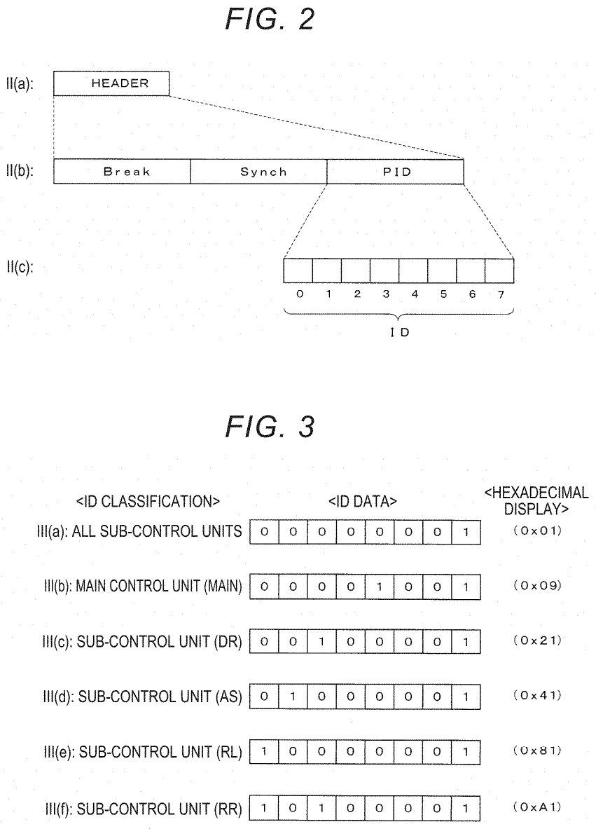

FIG. 2 shows an example of a confirmation request signal. As shown in the item II(a) in FIG. 2, the confirmation request signal is transmitted as a HEADER which is a LIN frame. As shown in the item II(b) in FIG. 2, the HEADER includes three fields: Break, Synch, and Protected ID (PID). “Break” is a field indicating the start of a frame, “Synch” is a field for synchronizing between a master unit and a slave unit, and “PID” is a field in which identification information (ID) of a master unit or a slave unit is recorded. As shown in the item II(c) in FIG. 2, the PID is composed of 8-bit (1 byte) data.

FIG. 3 shows an example of ID data recorded in the PID field. The ID data includes binary signals in which “0” and “1” are assigned to each 8-bit digit for each of the ID categories in the items III(a) to III(f) in FIG. 3. In the items III(a) to II(f) in FIG. 3, for convenience, the main control unit 50 is referred to as a “main control unit (MAIN)”, the sub-control unit 10 is referred to as a “sub-control unit (DR)”, the sub-control unit 20 is referred to as a “sub-control unit (AS)”, the sub-control unit 30 is referred to as a “sub-control unit (RL)”, and the sub-control unit 40 is referred to as a “sub-control unit (RR)” (the same applies to the items V(a) to V(d) in FIG. 5 described later).

In response to reception of a confirmation request signal from the main control unit 50, the sub-control units 10, 20, 30, and 40 confirm the state thereof and determine whether or not there is notification information of which the main control unit 50 is to be notified. This notification information is information of which the main control unit 50 is to be notified when there is a change in the status in the power window devices PW1 to PW4 of each seat. For example, in the power window device PW2, in a case where the operation of closing the window is performed by the assistant seat switch 23, the sub-control unit 10 determines that there is notification information, and returns the operation state of the assistant seat switch 23 to the main control unit 50 as notification information via the communication line L1. The terminal identification information (described later) for identifying the sub-control unit 10 is added to this notification information.

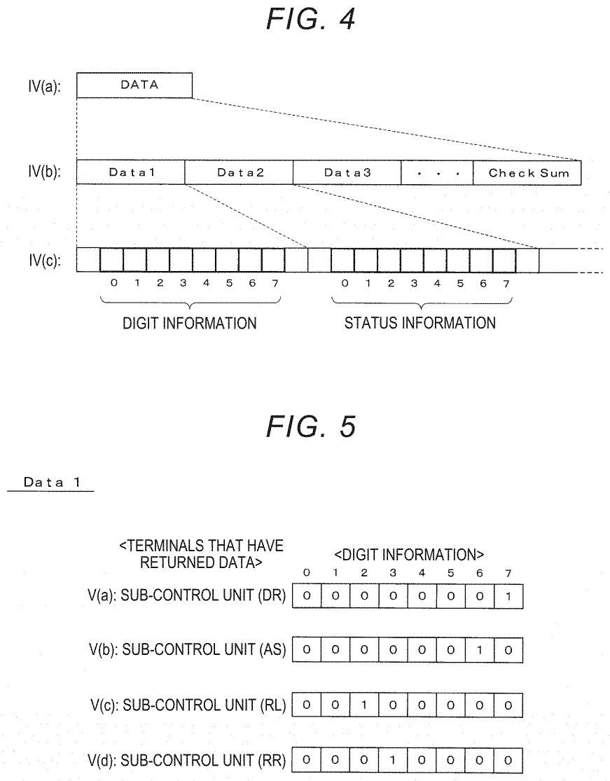

FIG. 4 shows an example of a response signal returned from the sub-control units 10, 20, 30, and 40 to the main control unit 50. This response signal includes the above-mentioned notification information and terminal identification information. As shown in the item IV(a) in FIG. 4, the response signal from the sub-control unit is transmitted as DATA which is a frame of LIN. As shown in the item IV(b) in FIG. 4, DATA includes a plurality of data fields Data 1, Data 2, Data 3 . . . . , and a Check Sum field. The data field is a data recording area in which data to be transmitted is recorded, and the checksum field is a data recording area for confirming whether the received data is correct. As shown in the item IV(c) in FIG. 4, digit information (described later) is recorded as terminal identification information in Data 1 of the data field, and status information (described later) is recorded as notification information in Data 2.

FIG. 5 shows an example of digit information recorded in Data 1 of the data field. The digit information is terminal identification information for identifying the sub-control unit that has returned the data, “1” is recorded in a specific one digit different for each sub-control unit, and all other digits are 8-bit (1 byte) data in which “0” is recorded. Specifically, in the digit information of the sub-control unit (DR) shown in the item V(a) in FIG. 5, “1” is recorded in the 7th bit digit, and all other digits are “0”. In the digit information of the sub-control unit (AS) shown in the item V(b) in FIG. 5. “1” is recorded in the 6th bit digit, and all other digits are “0”. In the digit information of the sub-control unit (RL) shown in the item V(c) in FIG. 5, “1” is recorded in the 2nd digit, and all the other digits are “0”. In the digit information of the sub-control unit (RR) shown in the item V(d) in FIG. 5, “1” is recorded in the 3rd digit, and all the other digits are “0”.

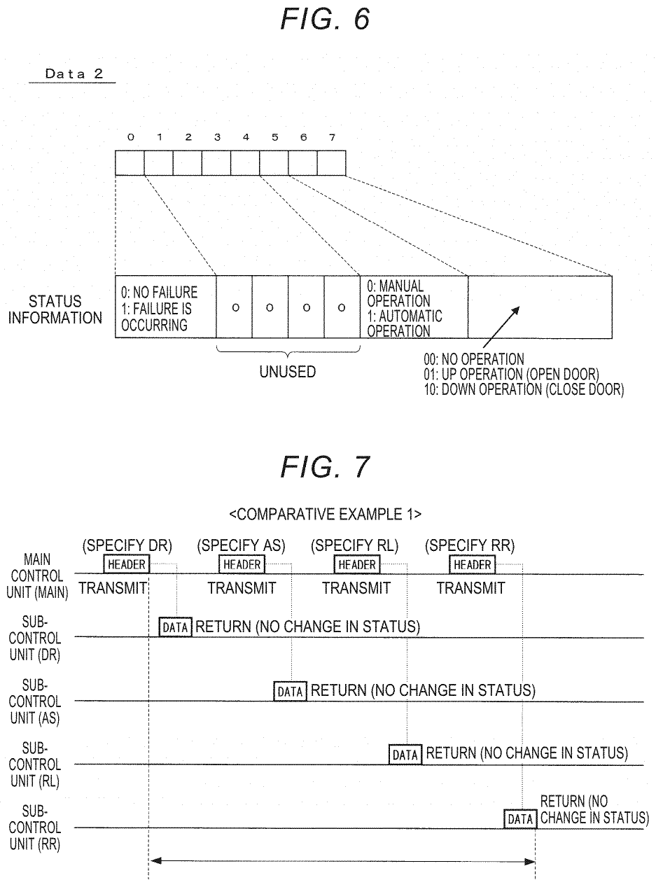

FIG. 6 shows an example of the status information recorded in Data 2 of the data field. The status information is notification information for notifying the main control unit 50 of the states of the sub-control units 10, 20, 30, and 40, and includes 8-bit (1 byte) data. Specifically, the presence or absence of a failure is recorded in the 0th bit of Data 2, “0” indicates that no failure has occurred, and “1” indicates that a failure is occurring. The 1st to 4th bits are unused areas, and “0” is recorded in all areas. From the 5th bit to the 7th bit, the operation mode of the switch of each seat is recorded. The 5th bit “0” indicates a manual operation in which the motor rotates and the window opens and closes only while a switch is operated, “1” indicates an automatic operation in which the motor continues to rotate even when the switch operation is released and the window fully opens or fully closes. “00” in the 6th to 7th bits indicates that there is no window opening/closing operation, “01” indicates an UP operation in which the window closes (rises), and “10” indicates a DOWN operation in which the window opens (descends).

In response to reception of a response signal (FIG. 4) including digit information and status information from the sub-control unit whose state has changed, the main control unit 50 specifies the sub-control unit based on the digit information (FIG. 5) and grasps the content of the status based on the status information (FIG. 6). Then, if the sub-control unit is, for example, the sub-control unit 40 of the rear right seat RR (see the item V(d) in FIG. 5) and the status is an auto DOWN operation (in FIG. 6, the 5th bit is “1” and the 6th to 7th bits are “10”), the main control unit 50 determines that the auto DOWN operation has been performed on the rear right seat switch 43. Then, the main control unit 50 transmits a command signal permitting the auto DOWN operation to the sub-control unit 40 after confirming that the operation contradictory to the operation is not performed on the rear right seat switch 17 of the main switch 13. In a case where the rear right seat switch 17 performs contradictory operations, a command signal for prohibiting the auto DOWN operation is transmitted. In response to reception of a permission command signal from the main control unit 50, the sub-control unit 40 outputs a control signal for the auto DOWN operation to the motor drive unit 42. As a result, the motor 44 is rotated by the motor drive unit 42, and the window of the rear right seat RR fully opens.

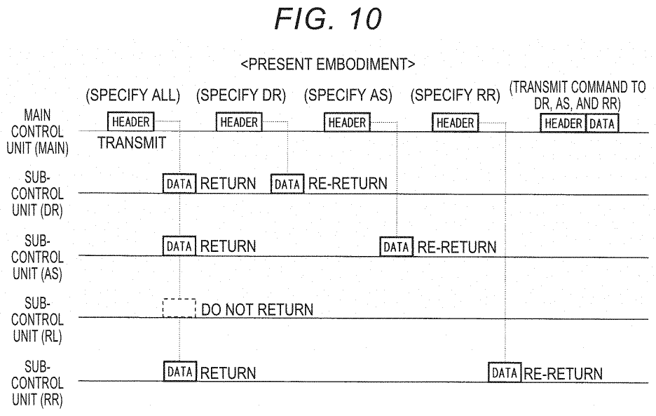

Next, the communication procedure between the main control unit 50 and the sub-control units 10, 20, 30, and 40 according to one or more embodiments of the inventions will be described in more detail with reference to FIGS. 7 to 10. FIGS. 7 to 9 show a communication procedure according to a comparative example, and FIG. 10 shows a communication procedure according to one or more embodiments of the inventions.

In Comparative Example 1 shown in FIG. 7, the main control unit sequentially transmits a confirmation request signal (HEADER) to each of the sub-control units at predetermined time intervals, and the sub-control unit that receives this signal returns a response signal (DATA) including terminal identification information regardless of presence or absence of a change in the status. In this case, the ID data of the items III(a) to III(f) in FIG. 3 is recorded in the PID field of FIG. 2 according to the sub-control unit at the transmission destination.

However, in such a communication procedure, for example, even in a case where there is a change in the status, the sub-control unit (RR) is in a state of waiting for the turn thereof until a confirmation request signal is received from the main control unit, and cannot return a response signal. Therefore, a time T1 from the transmission of the confirmation request signal to the return of the response signal becomes long, and the opening/closing operation of the window of the rear right seat RR is delayed.

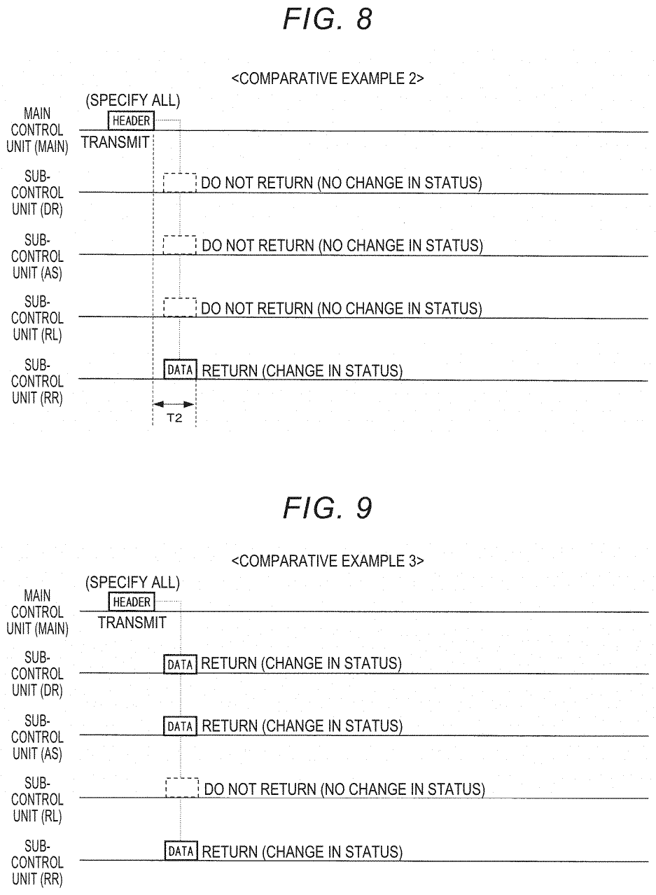

On the other hand, in Comparative Example 2 shown in FIG. 8, the main control unit transmits a confirmation request signal (HEADER) to all the sub-control units (DR, AS, RL, and RR) all at once at the same timing. Then, the sub-control unit that has received this signal does not return a response signal (DATA) if there is no change in the status, and returns a response signal only when there is a change in the status.

According to this communication procedure, for example, in a case where there is a change in the status, since the sub-control unit (RR) can immediately return a response signal without waiting for the turn thereof, a time T2 from the transmission of the confirmation request signal to the return of the response signal is shortened. Therefore, it is possible to avoid a delay in the opening/closing operation of the window of the rear right seat RR.

However, in the communication procedure of FIG. 8, there is no problem in a case where there is only one sub-control unit that has returned a response signal, but in a case where there is a plurality of sub-control units that has returned a response signal, there is a problem that the response signals returned at the same time overlap and the main control unit cannot recognize the data correctly. This will be described in more detail below.

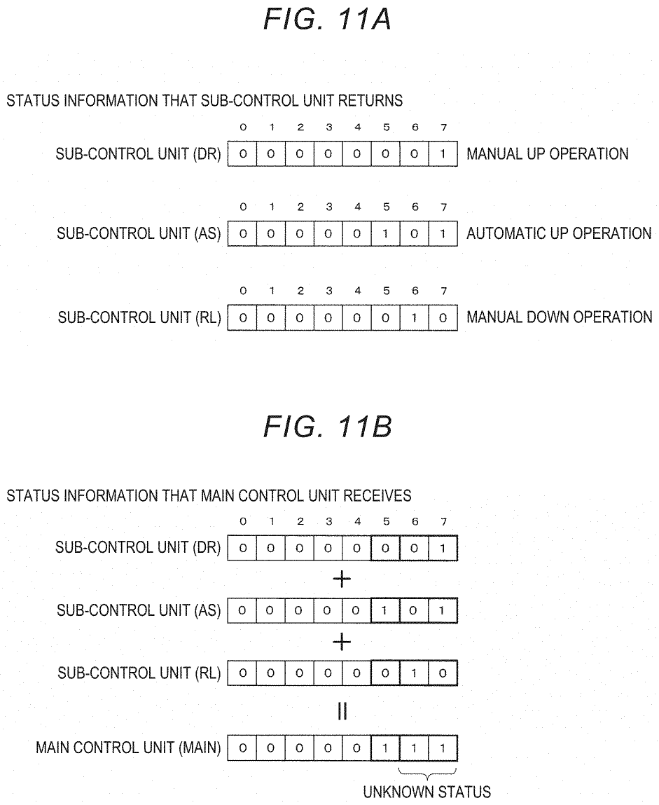

Comparative Example 3 in FIG. 9 shows a case where a plurality of sub-control units (DR, AS, and RR) whose status has changed return a response signal (DATA) for the confirmation request signal (HEADER) transmitted from the main control unit to each sub-control unit all at once at the same time. The status information (FIG. 6) included in this response signal is as shown in FIG. 11A, for example. The status of the sub-control unit (DR) is a manual UP operation, the status of the sub-control unit (AS) is an auto UP operation, and the status of the sub-control unit (RR) is a manual DOWN operation.

In a case where the plurality of sub-control units (DR, AS, and RR) returns a response signal at the same time, since the response signals are received in an overlapping manner in the main control unit, the status information included in each response signal is also received in an overlapping manner. As a result, as shown in FIG. 11B, the status information received by the main control unit is the sum of the status information of each sub-control unit, and is the information in which “1” is recorded in the 5th bit and “11” is recorded in the 6th to 7th bits.

Here, referring to FIG. 6, since “I” is defined as an automatic operation in the 5th bit of the status information, the main control unit can recognize that the status is “automatic operation” by the “1” recorded in the 5th bit of the received status information in FIG. 11B. However, the status of the sub-control unit (AS) is “automatic operation”, and the status of the sub-control unit (DR) and the sub-control unit (RR) whose the 5th bit is “0” is “manual operation”. Therefore, the main control unit erroneously recognizes the status of the sub-control unit (DR and RR).

On the other hand, in FIG. 6, since “II” is not defined in the 6th to 7th bits, the main control unit cannot recognize what kind of status “11” recorded in the 6th to 7th bits in the received status information of FIG. 11B is. Therefore, the main control unit cannot transmit a command signal for commanding permission/disapproval of an operation to the corresponding sub-control unit, which hinders the opening/closing operation of the window.

On the other hand, in one or more embodiments of the inventions, in a case where response signals are returned from the plurality of sub-control units at the same time, the above-mentioned problem is solved by identifying the sub-control unit that has returned a response signal based on the digit information (see the items V(a) to V(d) in FIG. 5) and adopting the procedure of individually re-transmitting a confirmation request signal to each of the identified sub-control units at different timings.

FIG. 10 shows an example of a communication procedure one or more embodiments of the inventions. In FIG. 10, the main control unit transmits a confirmation request signal (HEADER) to all the sub-control units (DR, AS, RL, and RR) at the same timing all at once, and the sub-control unit returns a response signal (DATA) only when there is a change in the status. This point is the same as in FIG. 9.

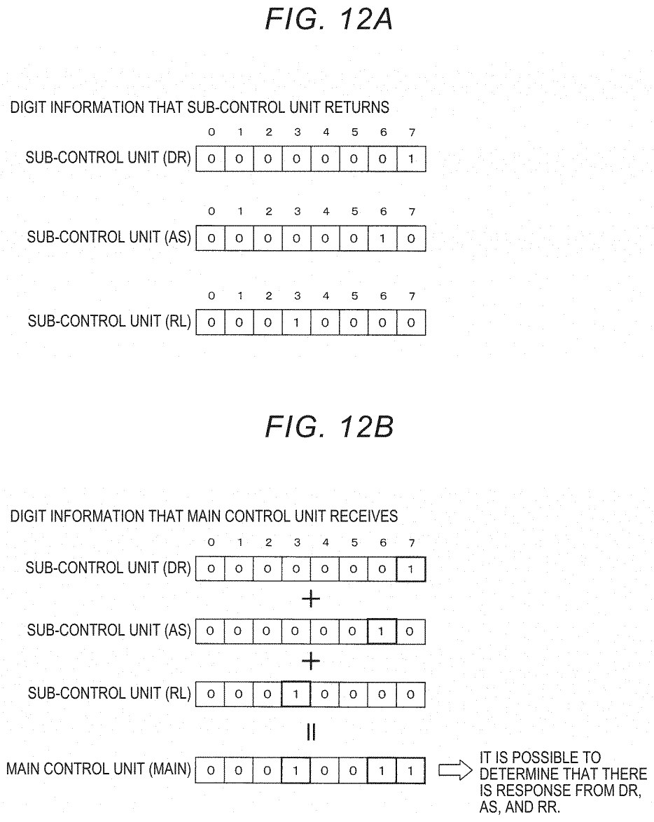

Here, in a case where response signals are returned from the plurality of sub-control units (DR, AS, and RR) at the same time, the main control unit first determines which sub-control unit has returned a response signal based on the received digit information. FIG. 12A shows an example of digit information included in the response signals returned by the sub-control units (DR, AS, and RR). The respective digit information is the same as that shown in the items V(a), V(b) and V(d) in FIG. 5. As described above, when the plurality of sub-control units returns response signals at the same time, since the response signals are received in an overlapping manner in the main control unit, the digit information included in each response signal is also received in an overlapping manner.

As a result, as shown in FIG. 12B, the digit information received by the main control unit is the sum of the digit information of each sub-control unit, and is the information in which “1” is recorded in the 3rd bit, the 6th bit, and the 7th bit, respectively. Here, since the position of “1” in the digit information is different for each sub-control unit as shown in the items V(a) to V(d) in FIG. 5, the main control unit determines that the response signals are transmitted from the plurality of sub-control units at the same time because “1” is recorded in two or more digits in the received digit information. Then, the main control unit recognizes that a response signal has been returned from the sub-control unit (RR) by the 3rd bit “1”, recognizes that a response signal has been returned from the sub-control unit (AS) by the 6th bit “1”, and recognizes that a response signal has been returned from the sub-control unit (DR) by “1” in the 7th bit. Thereby, the main control unit can identify the sub-control unit that has returned a response signal.

On the other hand, the status information is the same as in FIGS. 11A and 11B, and the status information of the plurality of sub-control units (DR, AS, and RR) may overlap and the main control unit may not be able to correctly recognize the status. However, even in this case, as described above, the main control unit can recognize from which sub-control unit the response signal has been returned. Therefore, the main control unit then individually re-transmits a confirmation request signal to the sub-control units that have returned a response signal at different timings.

Specifically, in FIG. 10, in a case where it is determined that the plurality of sub-control units has returned a response signal at the same time, the main control unit first specifies the sub-control unit (DR) and transmits a confirmation request signal (HEADER) again. The sub-control unit (DR) is specified by recording the ID data of the item III(c) in FIG. 3 in the PID field of the item II(b) in FIG. 2. In response to reception of a confirmation request signal, the sub-control unit (DR) determines again whether or not there is status information of which the main control unit is to be notified, and in a case where there is such information, re-returns a response signal (DATA) including the digit information and the status information to the main control unit.

Next, the main control unit specifies the sub-control unit (AS) and transmits a confirmation request signal (HEADER). The sub-control unit (AS) is specified by recording the ID data of the item III(d) in FIG. 3 in the PID field of the item II(b) in FIG. 2. In response to reception of a confirmation request signal, the sub-control unit (AS) determines again whether or not there is status information of which the main control unit is to be notified, and in a case where there is such information, re-returns a response signal (DATA) including the digit information and the status information to the main control unit.

Next, the main control unit specifies the sub-control unit (RR) and transmits a confirmation request signal (HEADER). The sub-control unit (RR) is specified by recording the ID data of the item III(f) in FIG. 3 in the PID field of the item II(b) in FIG. 2. In response to reception of a confirmation request signal, the sub-control unit (RR) determines again whether or not there is status information of which the main control unit is to be notified, and in a case where there is such information, re-returns a response signal (DATA) including the digit information and the status information to the main control unit.

When a response signal is re-returned from the sub-control unit (DR, AS, and RR), the main control unit transmits a command signal for commanding permission or prohibition of an operation to each sub-control unit. This command signal includes Header in which the ID of the sub-control unit at a transmission destination is recorded, and DATA in which the content of the command is recorded. In response to reception of a permission command signal from the main control unit, each sub-control unit executes control according to the respective status thereof. As a result, the power window devices PW1 to PW4 of each seat perform a predetermined operation based on a switch operation.

According to the above-described embodiment, a confirmation request signal is transmitted from the main control unit 50 to all the sub-control units 10, 20, 30, and 40 at the same timing all at once. Then, when the sub-control unit that needs to notify the main control unit 50 receives this confirmation request signal, since the sub-control unit immediately returns a response signal, the time from the transmission of the confirmation request signal to the return of the response signal can be shortened, and the communication time between the main control unit 50 and the sub-control units 10, 20, 30, and 40 can be shortened.

Further, in the above-described embodiment, in a case where response signals are returned from the plurality of sub-control units to the main control unit at the same time, the main control unit 50 identifies the sub-control units that have returned a response signal based on the digit information, and individually re-transmits a confirmation request signal to those sub-control units. Then, based on the response signal re-returned from the corresponding sub-control unit, the main control unit 50 transmits a command signal for commanding permission/disapproval of an operation to each sub-control unit, and the sub-control unit executes control according to the command signal. Therefore, even in a case where the response signals returned by the sub-control units overlap, the operation of the power window devices PW1 to PW4 of each seat is not hindered, and the opening/closing control of the window can be accurately performed.

Further, in the above-described embodiment, in FIG. 10, when the response signals from the sub-control units overlap, the main control unit specifies only the sub-control units (DR, AS, and RR) whose status has been changed and that have returned a response signal to individually re-transmits a confirmation request signal, and does not individually re-transmit a confirmation request signal to the sub-control unit (RL) whose status has not been changed and has not returned a response signal. Therefore, the amount of communication between the main control unit and the sub-control units is reduced, and the total communication time can be further shortened.

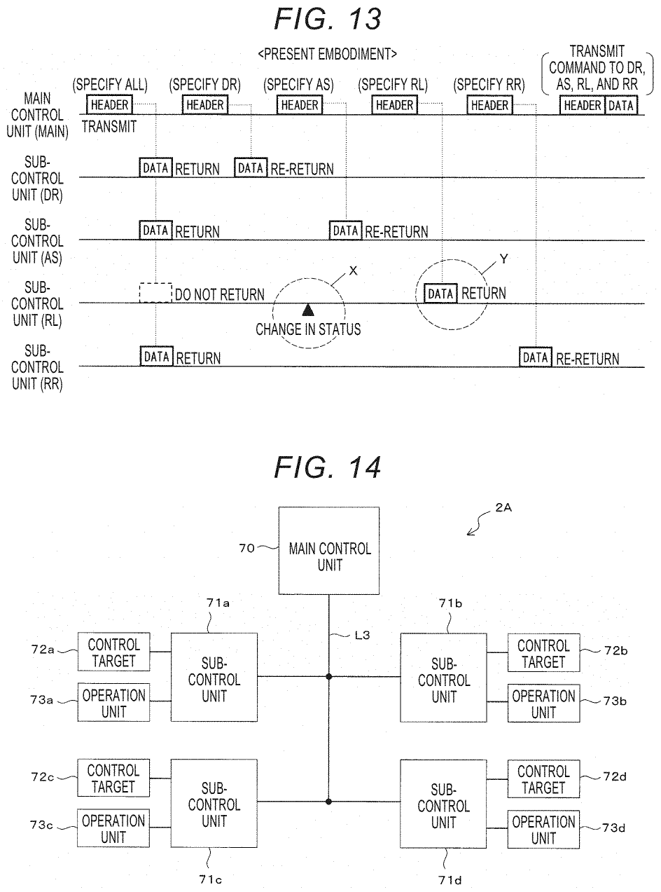

FIG. 13 shows another example of the communication procedure according to one or more embodiments of the inventions. In FIG. 10, as described above, a confirmation request signal is individually re-transmitted only to the sub-control units (DR, AS, and RR) that have returned a response signal, but in FIG. 13, a confirmation request signal is individually re-transmitted not only to the sub-control units (DR, AS, and RR) that have returned a response signal, but also to the sub-control unit (RL) that has not returned a response signal.

In this way, at the time when confirmation request signals are first transmitted all at once, in the sub-control unit (RL) whose status has not been changed and has not returned a response signal, in a case where the status has been changed thereafter (dashed line X), a response signal is returned from this sub-control unit (RL) to the main control unit (dashed line Y). Therefore, the main control unit can transmit a command signal to the sub-control unit (RL) without waiting for the next simultaneous transmission, and avoid a delay in the operation of the sub-control unit (RL).

In the above-described embodiment, the power window system 1A is taken as an example of the communication system, but one or more embodiments of the inventions is not limited to thereto, and can be widely applied to a general communication system 2A including, for example, a single main control unit 70, a plurality of sub-control units 71a, 71b, 71c, and 71d that communicates with the main control unit 70 via a communication line L3 and individually control a plurality of control targets 72a, 72b, 72c, and 72d, respectively, and a plurality of operation units 73a, 73b. 73c, and 73d for causing control targets 72a, 72b. 72c, and 72d to perform a predetermined operation, as shown in FIG. 14.

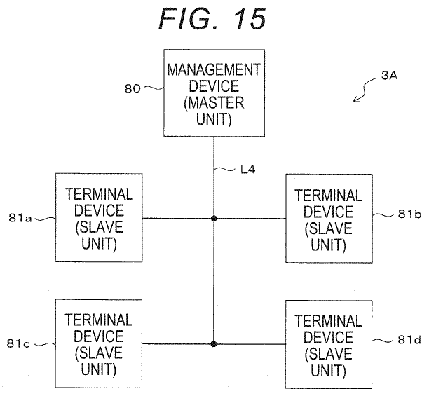

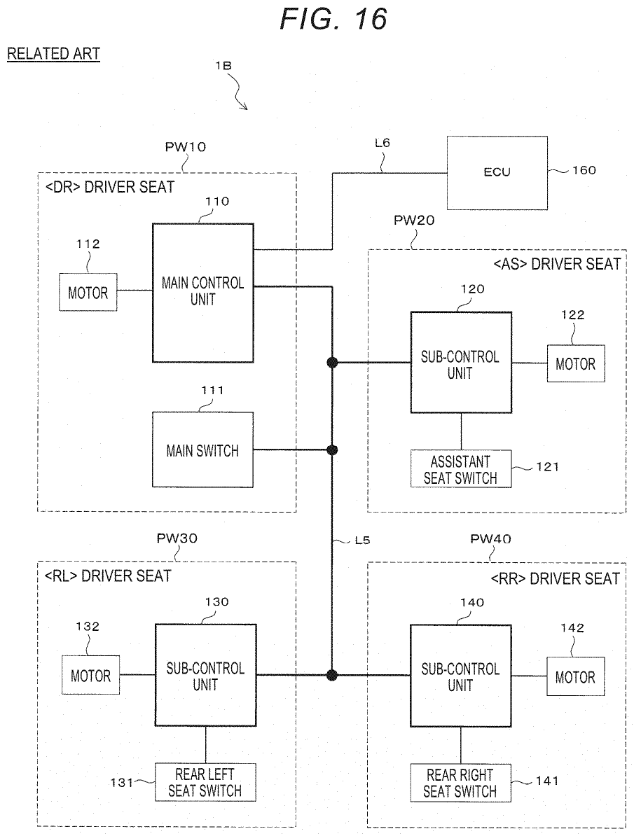

Further, one or more embodiments of the inventions can also be widely applied to a more general communication system 3A including, for example, a management device 80 as a master unit, terminal devices 81a, 81b, 81c, and 81d as slave units, and a communication line L4 coupling therebetween, as shown in FIG. 15.

In addition to the above-described embodiment, various embodiments such as the following can be adopted in one or more embodiments of the inventions.

In the items V(a) to V(d) in FIG. 5, the digit information in which “1” is recorded in a specific one digit is taken as an example, but depending on the number of sub-control units, the digit information may be such that “1” is recorded in a specific two-digit number or more digits. Further, the digit information may be data other than 8 bits. Further, the data recorded in the specific digit may be data other than “1”.

In FIG. 10, an example is given in which a command signal is transmitted from the main control unit to the sub-control units (DR. AS, and RR) after the re-return of the response signals from the plurality of sub-control units (DR. AS, and RR) is completed, but a command signal may be transmitted to the sub-control unit each time a response signal is re-returned from each sub-control unit. The same applies to the case of FIG. 13.

In FIG. 1, a local interconnect network (LIN) is taken as an example of the communication line L1, but the communication line in one or more embodiments of the inventions may be a local area network (LAN) or a controller area network (CAN). Further, the communication line may be wired or wireless.

In FIG. 1, the power window system 1A provided with four power window switches PW1 to PW4 is taken as an example, but the number of power window switches may be two or six depending on the vehicle.

In FIG. 1, a motor for opening and closing a vehicle window is taken as an example as a control target, but the control target is not limited thereto, and may be, for example, a motor for driving an electric mirror equipped in a vehicle door. Further, the control target may be an in-vehicle device other than the motor.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A communication system comprising:
a management device that constitutes a master unit;
a terminal device that constitutes a slave unit; and
a communication line that couples the management device and the terminal device,
wherein a plurality of terminal devices is provided,
wherein the management device and the plurality of terminal devices communicate with each other via the communication line,
wherein the management device transmits a confirmation request signal requesting confirmation of a state of the terminal device to each of the plurality of terminal devices at the same timing all at once,
wherein each of the plurality of terminal devices is configured:
to confirm the state of the terminal device to determine whether or not there is notification information of which the management device is notified, in response to reception of the confirmation request signal; and
to return the notification information to the management device together with terminal identification information for identifying the terminal device in a case where there is the notification information,
wherein the management device is configured:
to identify the terminal device that has returned the notification information based on the terminal identification information in a case where the notification information is returned from the plurality of terminal devices at the same timing; and
to individually re-transmit the confirmation request signal to each of the identified terminal devices at different timings, and
wherein the terminal device, which has received the re-transmitted confirmation request signal, re-returns the notification information to the management device together with the terminal identification information in a case where there is the notification information.

2. The communication system according to claim 1,
wherein the terminal identification information is digit information in which predetermined data is recorded in a specific digit different for each terminal device among a plurality of digits constituting a data recording area, and
wherein in response to reception of the terminal identification information, in a case where the predetermined data is recorded in a predetermined number of digits or more, the management device determines that the notification information is returned from the plurality of terminal devices at the same time.

3. The communication system according to claim 1,
wherein the terminal device is configured:
to determine that there is the notification information and transmit the notification information to the management device together with the terminal identification information in a case where there is a change in the state of the terminal device; and
to determine that there is no notification information and not to transmit the notification information to the management device in a case where there is no change in the state of the terminal device.

4. The communication system according to claim 1,
wherein the management device includes a single main control unit that communicates with the plurality of terminal devices via the communication line, and
wherein the plurality of terminal devices includes a plurality of sub-control units that individually controls each of control targets provided corresponding to each terminal device.

5. The communication system according to claim 4,
wherein the main control unit, the sub-control units, and the communication line are mounted on a vehicle,
wherein the sub-control unit is provided corresponding to each seat of the vehicle, and
wherein the control target is a motor for opening and closing a window of each seat of the vehicle.

6. A management device that is coupled to a plurality of terminal devices by a communication line and communicates with the terminal devices via the communication line,
wherein the management device is configured:
to transmit a confirmation request signal requesting confirmation of a state of the terminal device to each of the plurality of terminal devices at the same time all at once;
to identify the terminal devices that have returned the notification information based on the terminal identification information in response to reception of notification information indicating the state of the terminal device and terminal identification information for identifying the terminal device from the terminal device; and
to individually re-transmit the confirmation request signal to each of the identified terminal devices at different timings.

7. The management device according to claim 6,
wherein in a case where the notification information is returned from the plurality of the terminal devices at the same time,
the management device is configured:
to individually re-transmit the confirmation request signal only to the terminal device that has returned the notification information; and
not to individually re-transmit the confirmation request signal to the terminal device that has not returned the notification information.

8. The management device according to claim 6,
wherein in a case where the notification information is returned from the plurality of terminal devices at the same time, and
wherein the management device individually re-transmits the confirmation request signal to both the terminal device that has returned the notification information and the terminal device that has not returned the notification information.

9. A terminal device that is coupled to a management device by a communication line and communicates with the management device via the communication line,
wherein the terminal device is configured:
in response to reception of a confirmation request signal requesting confirmation of a state of the terminal device, the confirmation request signal being transmitted from the management device at the same timing all at once, to confirm the state of the terminal device to determine whether or not there is notification information of which the management device is to be notified;
in a case where there is the notification information, to return the notification information to the management device together with terminal identification information for identifying the terminal device;
in a case where the notification information is returned to the management device from a plurality of terminal devices at the same time, in response to reception of the confirmation request signal that is individually re-transmitted from the management device to each terminal device at different timings, to determine again whether or not there is notification information of which the management device is to be notified; and
in a case where there is the notification information, to re-return the notification information to the management device together with the terminal identification information.
